(19) United States
(12) Patent Application Publication
(10) Pub. No.: US 2003/0057033 A1
(43) Pub. Date: Mar. 27, 2003

(54) Fixation plate of a foot-operated bicycle braking system

(75) Inventors: Chien-Hsiang Lin, Chang-Hua Hsien (TW); Chen-Chih Lin, Chang-Hua Hsien (TW)

Correspondence Address: Harrison& Egbert, 412 Main ST., 7th Floor, Houston, TX, 77002, US

(73) Assignee: Chin Hsing An Thai Industrial Co., Ltd.

(21) Appl. No.: 09/957,603

(22) Filed: Sep. 21, 2001

(51) Int. Cl. B62L 5/00

(52) U.S. Cl. 188/26; 188/24.11

(57) ABSTRACT

A foot-operated bicycle braking system comprises a fixation plate having a mounting arm and two retaining arms. The mounting arm is provided with a mounting hole for mounting the fixation plate on a support shaft of the braking system. The two retaining arms are provided with a retaining portion and a receiving hole. The bicycle rear fork is retained by the fixation plate such that the rear fork is retained securely between the mounting arm and the two retaining portions of the retaining arms, and that the rear fork is located by a locating bolt which is received in the receiving holes of the retaining arms.

### BACKGROUND OF THE INVENTION

1. Field of the Invention

The present invention relates generally to a foot-operated bicycle braking system, and more particularly to a fixation plate of the foot-operated bicycle braking system.

2. Description of Related Art

The minibike is generally intended for use in exercise or amusement. The minibike has a lightweight frame and a low cruising speed. As a result, certain minibikes are not provided with a braking system; nevertheless certain minibikes are provided with a foot operated braking system.

As shown in FIGS. 6 and 7, a foot-operated bicycle braking system of the prior art comprises a hub 20, a support shaft 30, a fly wheel 40, two rear forks 70, and a fixation plate 80. The braking action is effected by the fly wheel 40 which is caused by the pedals to turn in reverse so as to force the hub 20 to stop spinning in conjunction with the locking mechanism brought about jointly by the support shaft 30, the rear forks 70, and the fixation plate 80. The fixation plate 80 is mounted on the support shaft 30 such that the fixation plate 80 is fastened with the rear fork 70 by a fastening bolt 82 which is put through the through hole 81 of the fixation plate 81 and the through hole 71 of the rear fork 70. The rear fork main body 70 and the fixation plate 80 must be provided respectively with the through hole 71, 81, thereby resulting in an increase in the production cost. In addition, the through holes 71 and 81 must be aligned. The alignment of the through holes 71 and 81 of the rear fork main body 70 and the fixation plate 80 gives an added complication to the production process. In the event that the rear fork main body 70 is devoid of the through hole 71, as shown in FIG. 7, the rear fork main body 70 is provided with a retaining ring 90 in place of the through hole 71. The retaining ring 90 is costly and apt to make the assembly work time-consuming. The rear fork main body 70 and the fixation plate 80 are apt to become unfastened after a prolonged operation of the bicycle. In addition, the blot 82 or the retaining ring 90 is not structural strong to withstand the torsion for a long period of time.

### BRIEF SUMMARY OF THE INVENTION

The primary objective of the present invention is to provide a foot-operated bicycle braking system with an improved fixation plate having a mounting arm and two retaining arms. The mounting arm is provided with a mounting hole for mounting the fixation plate on the support shaft of the braking system. The rear fork is securely retained in the space between the mounting arm and the retaining arms in conjunction with a locating bolt.

The features and advantages of the present invention will be more readily understood upon a thoughtful deliberation of the following detailed description of a preferred embodiment of the present invention with reference to the accompanying drawings.

### BRIEF DESCIPTION OF THE SEVERAL VIEWS OF THE DRAWINGS

FIG. 1 shows a schematic view of a bicycle which is equipped with a foot-operated brake of the present invention.

FIG. 2 shows a perspective view of the foot-operated bicycle braking system of the present invention.

FIG. 3 shows an exploded view of the foot-operated bicycle braking system of the present invention.

FIG. 4 shows a rear view of the foot-operated bicycle braking system of the present invention along with the bicycle as shown in FIG. 1.

FIG. 5 shows a side view of the present invention along with the rear wheel of the bicycle as shown in FIG. 1.

FIG. 6 shows an exploded view of a foot-operated bicycle braking system of the prior art.

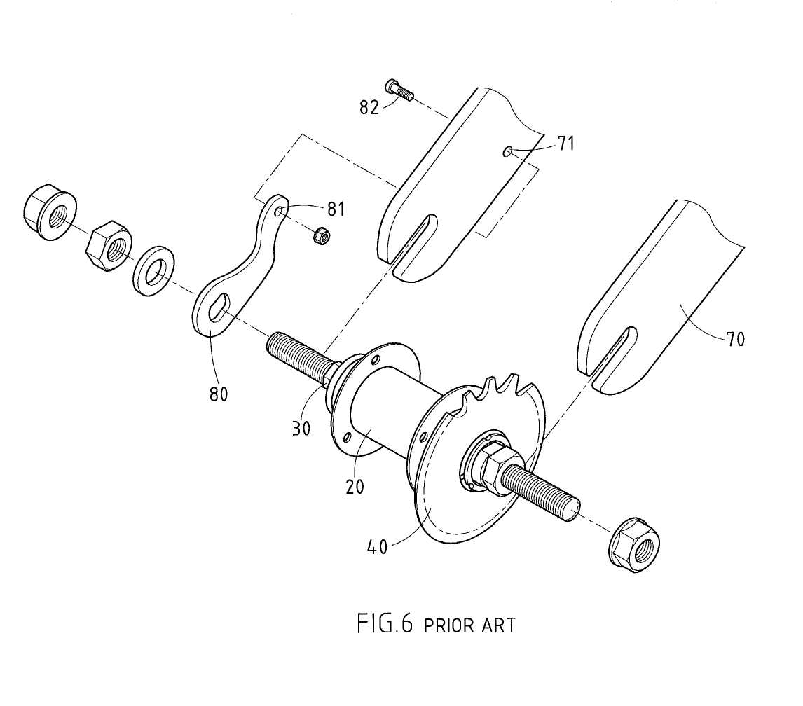

FIG. 7 shows an exploded view of another foot-operated bicycle braking system of the prior art.

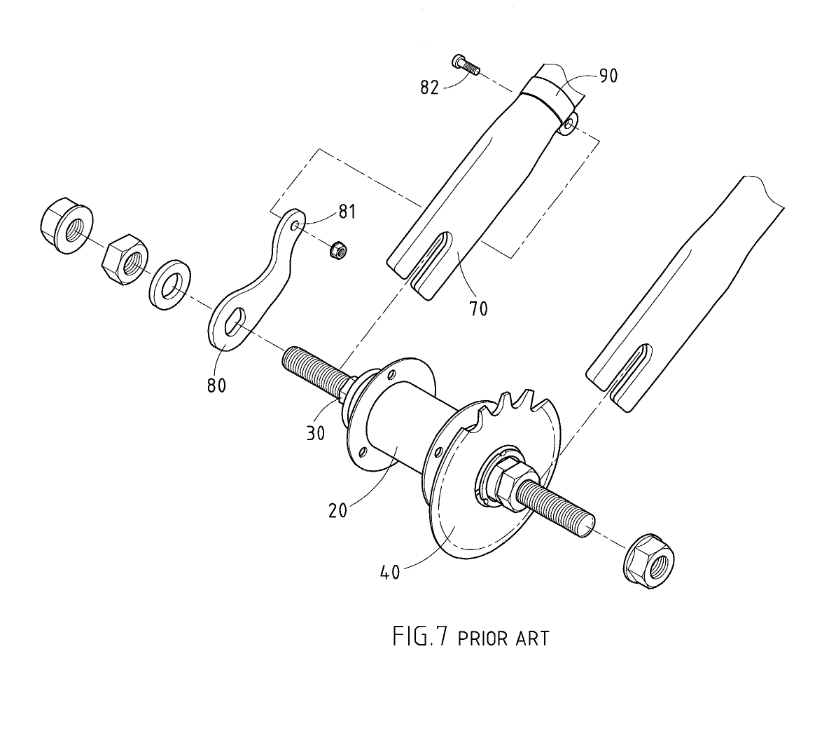

### DETAILED DESCRIPTION OF THE INVENTION

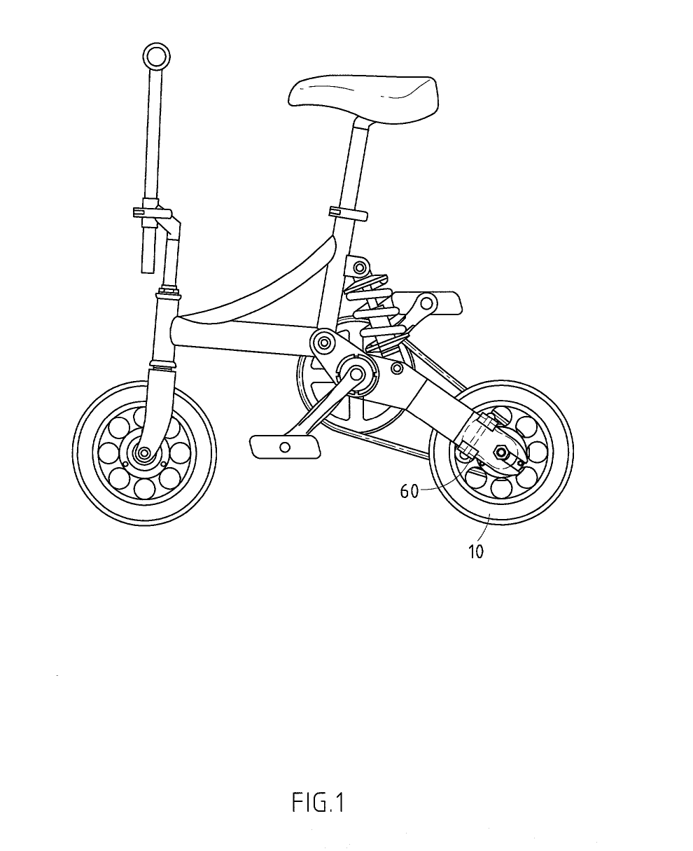

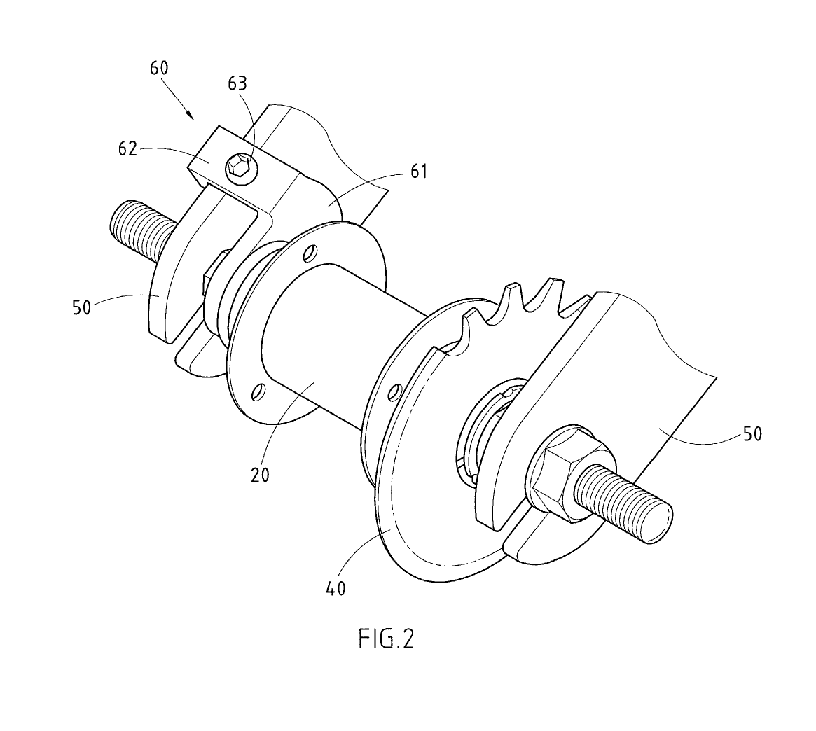

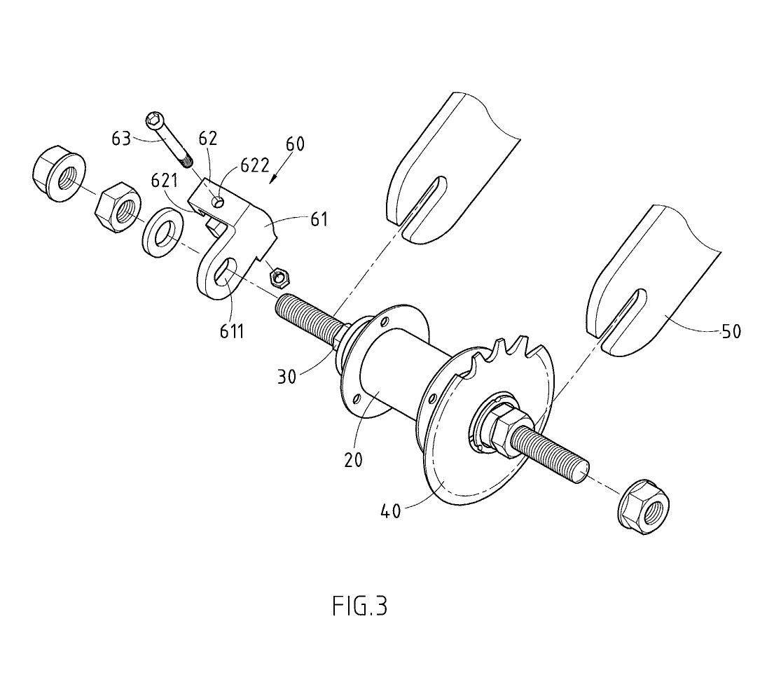

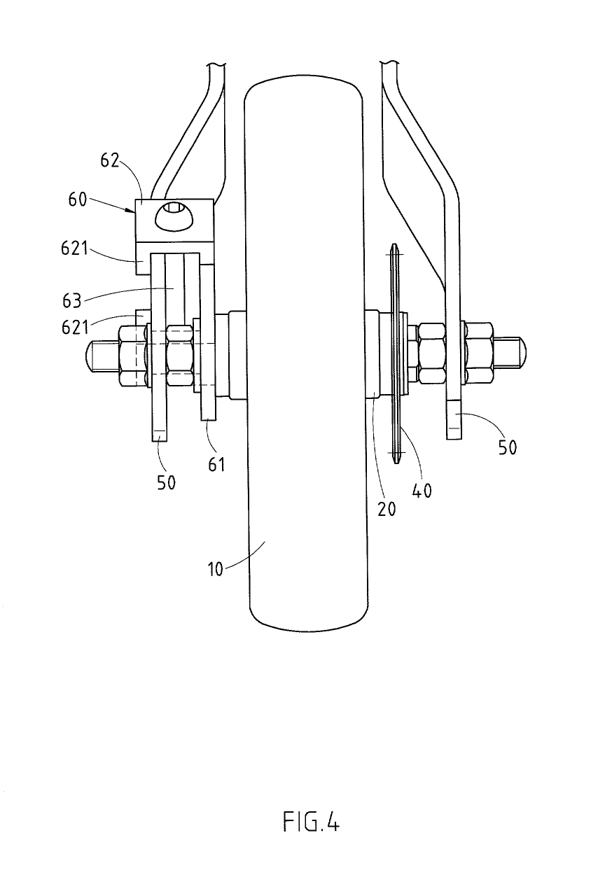

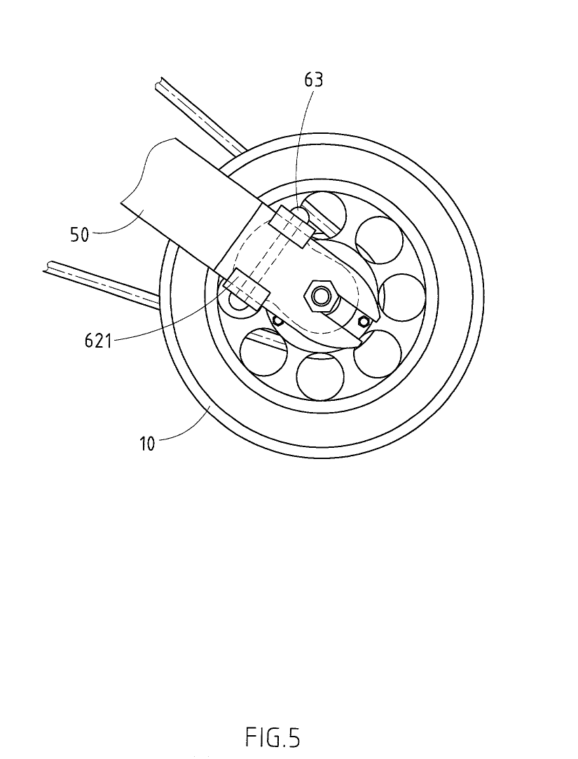

As shown in FIGS. 1-5, a foot-operated bicycle braking system of the preferred embodiment of the present invention comprises a hub 20, a support shaft 30 fastened with one end of the hub 20, a fly wheel 40 fastened with other end of the hub 20 and driven buy a sprocket chain of the bicycle, and a fixation plate 60 for retaining the bicycle rear fork 50. The braking action is effected by causing the fly wheel 40 to turn in reverse so as to bring about the locking mechanism in conjunction with the tub 20, the support shaft 30, the rear fork 50, and the fixation plate 60. In light of the braking action, the bicycle rear wheel 10 in motion is slowed down or stopped.

The present invention is characterized by the fixation plate 60 which has a mounting arm 61 and two retaining arms 62. The mounting arm 61 is provided with a mounting hole 611 by means of which the fixation plate 60 is mounted on the support shaft 30. The two retaining arms 62 are provided with a retaining portion 621 and a receiving hole 622. The rear fork 50 is securely retained between the mounting arm 61 and the two retaining portions 621 of the two retaining anus 62. In addition, the rear fork 50 is located by a locating blot 63 which is received in the receiving holes 622 of the retaining arms 62.

The fixation plate 60 of the present invention is compatible with any type of the bicycle rear fork. In light of simple construction of the fixation plate 60 of the present invention, the foot-operated bicycle braking system of the present invention is durable and cost-effective.

The embodiment of the present invention described above is to be regarded in all respects as being merely illustrative and not restrictive. Accordingly, the present invention may be embodied in other specific forms without deviating from the spirit thereof. The present invention is therefore to be limited only by the scope of the following claim.

I claim:

1. A foot-operated bicycle braking system comprising:
a hub;
a support shaft fastened with one end of said hub;
a fly wheel fastened with other end of said hub and driven by a sprocket chain of the bicycle; and
a fixation plate mounted on said support shaft for retaining a rear fork of the bicycle;
wherein said fixation plate has a mounting arm and two retaining arms, with said mounting arm being provided with a mounting hole for mounting said fixation plate on said support shaft, said two retaining arms being provided with a retaining portion and a receiving hole whereby said fixation plate retains the bicycle rear fork in such a manner that the rear fork is retained between said mounting arm and said two retaining portions of said two retaining arms, and that the rear fork is located by a locating bolt which is received in said receiving holes of said two retaining arms.
